(19) United States
(12) Patent Application Publication
(10) Pub. No.: US 2007/0072124 A1
(43) Pub. Date: Mar. 29, 2007

(54) Optical recording composition, production method thereof and optical recording medium

(75) Inventor: Satoru Yamada, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/522,973

(22) Filed: Sep. 19, 2006

(30) Foreign Application Priority Data
Sep. 20, 2005 (JP) 2005-272968

(51) Int. Cl. G11B 7/24

(52) U.S. Cl. 430/270.11

(57) ABSTRACT

A optical recording composition is provided that comprises a matrix and a monomer, wherein the matrix comprises a polyfunctional isocyanate, a radical-polymerizable compound and a polyfunctional alcohol, and the radical-polymerizable compound contains at least one of an amino group, a carboxyl group, an acid anhydride and an isocyanate group; and also an optical recording is provided that is formed from the optical recording composition.

### BACKGROUND OF THE INVENTION

1. Field of the Invention

The present invention relates to optical recording compositions, for producing optical recording media in particular suited for producing volume-type holographic optical recording media, in which the recording media have thicker recording layers and are capable of recording and reproducing information by use of laser light; methods for producing the optical recording compositions and optical recording media.

2. Description of the Related Art

Holographic optical recording media have been heretofore developed on the basis of holography. Information is recorded onto the holographic optical recording media by way of overlapping lights having image information and reference lights in recording layers formed of photosensitive compositions, and writing the resulting interference stripes onto recording layers. On the other hand, information lights are reproduced by way of irradiating reference lights onto recording layers at certain angles and causing optical diffraction of the reference lights by action of the interference stripes.

Volume holography, in particular digital volume holography, has recently been developed in feasible regions and has been attracting attention with respect to the possibility of ultra high-density optical recording. In the volume holography, the optical recording media are utilized aggressively in their thickness direction as well and the interference stripes are three-dimensionally written, providing features that larger thicknesses lead to higher diffraction efficiencies and larger recording capacities by use of multiple recording. In the digital volume holography, the recording is carried out in the similar recording media and manners as volume holography except that the recording image information is exclusively binarized into digital patterns so as to adapt to computers. In the digital volume holography, for example, analog image information such as pictures is once digitized to represent as two-dimension digital pattern information, which is recorded as image information. Upon reproduction, the digital pattern information is read and decoded, thereby to express the original image information. These processes may make possible to reproduce extremely faithfully the original information, even when S/N ratio (ratio of signal to noise) is somewhat lower by way of derivative detection and/or correcting errors through coding the binarized data (Japanese Patent Application Laid-Open (JP-A) No. 11-311936).

These volume holographic optical recording media are demanded for the features that the properties capable of multiple-recording are sufficiently performed and surface information is recorded and reproduced with higher resolutions. From these viewpoints, a holographic recording composition is proposed that has a self-sealing property (JP-A No. 2005-502918).

From the view point of fixing records, a technology is also proposed for attaching compounds having a polymerizable site to a matrix (JP-A Nos. 2001-40275 and 07-199777). However, the matrix is initially formed according to this proposal and the composition is liable to be viscous, thus there exist a problem that solvents are necessary to prepare optical recording media.

### SUMMARY OF THE INVENTION

It is an object of the present invention to provide optical recording compositions that afford production of high-sensitive high multiplicity optical recording media with higher efficiencies and lower costs with no use of solvents; another object of the present invention is to provide methods for producing the optical recording composition; and another object of the present invention is to provide optical recording media formed from the optical recording compositions.

The present inventors have investigated vigorously to solve the problems described above and have taken the following findings: that is, optical recording compositions comprising a matrix that contains (i) a polyfunctional isocyanate, (ii) a radical-polymerizable compound and (iii) a polyfunctional alcohol, and a monomer may afford the production of high-sensitive high multiplicity optical recording media with higher efficiencies and lower costs with no use of solvents, thus problems in the prior art may be effectively solved.

In the first embodiment, the optical recording compositions according to the present invention comprise a matrix that contains a polyfunctional isocyanate, a radical-polymerizable compound and a polyfunctional alcohol, and a monomer; the radical-polymerizable compound has at least one of an amino group, a carboxyl group, an acid anhydride and an isocyanate group.

In the second embodiment, the optical recording compositions according to the present invention comprise a matrix that contains a polyfunctional isocyanate, a monofunctional radical-polymerizable compound and a polyfunctional alcohol, and a monomer; the monofunctional radical-polymerizable compound has a hydroxyl group.

The inventive methods for producing an optical recording composition, in the first embodiment, comprise a step of forming a matrix, in which a polyfunctional isocyanate, a radical-polymerizable compound having at least one of an amino group, a carboxyl group, an acid anhydride and an isocyanate group, and a polyfunctional alcohol are mixed and thermosetted thereby to form a three-dimensional crosslinked matrix.

The inventive methods for producing an optical recording composition, in the second embodiment, comprise a step of forming a matrix, in which a polyfunctional isocyanate, a monofunctional radical-polymerizable compound having a hydroxyl group, and a polyfunctional alcohol are mixed and thermosetted thereby to form a three-dimensional crosslinked matrix.

The optical recording media according to the present invention comprise a holographic recording layer formed from either the first or the second embodiment of the optical recording composition according to the present invention.

### BRIEF DESCRIPTION OF THE DRAWINGS

FIG. 1 is a schematic cross section that exemplarily shows an optical recording medium of the first embodiment according to the present invention.

FIG. 2 is a schematic cross section that exemplarily shows an optical recording medium of the second embodiment according to the present invention.

FIG. 3 is an exemplary view that explains an optical system around the inventive optical recording medium.

FIG. 4 is a block diagram that shows exemplarily an entire construction of an optical recording and reproducing apparatus equipped with an optical recording medium according to the present invention.

### DESCRIPTION OF THE PREFERRED EMBODIMENTS

Optical Recording Composition

The optical recording compositions according to the present invention comprise a matrix that contains a polyfunctional isocyanate, a radical-polymerizable compound and a polyfunctional alcohol, and a monomer, and also as required a photopolymerization initiator and other ingredients.

Monomer

The monomer, which shows a relation with information recording, may preferably be a radical-polymerizable compound. The radical-polymerizable compound may be properly selected depending on the purpose; examples thereof include radical-polymerizable monomers having an unsaturated bond such as acrylic group and a methacrylic group. These monomers may be monofunctional or polyfunctional.

Examples of the radical polymerizable monomers include acryloyl morpholine, phenoxyethylacrylate, isobornylacrylate, 2-hydroxypropylacrylate, 2-ethylhexylacrylate, 1,6-hexanediol diacrylate, tripropyleneglycol diacrylate, neopentylglycol PO modified diacrylate, 1,9-nonandiol diacrylate, hydroxylpivalic acid neopentylglycoldiacrylate, EO modified bisphenol A diacrylate, polyethyleneglycol diacrylate, pentaerythritol triacrylate, pentaerythritol tetraacrylate, pentaerythritol hexaacrylate, EO modified glycerol triacrylate, trimethylolpropane triacrylate, EO modified trimethylolpropane triacrylate, 2-naphtho-1-oxyethylacrylate, 2-carbazoyl-9-ylethylacrylate, (trimethylsilyloxy)dimethylsilyl propylacrylate, vinyl-1-naphthoate, N-vinylcarbazol, 2,4-dibromophenylacrylate, 2,4,6-tribromophenylacrylate, pentabromophenylacrylate, phenylthioethylacrylate and tetrahydrofurfurylacrylate. These may be used alone or in combination. Among these, 2,4,6-tribromophenylacrylate, 2,4-dibromophenylacrylate and N-vinylcarbazol are preferable in particular.

The content of the monomer in the optical recording composition is preferably 5% by mass to 50% by mass, more preferably 5% by mass to 20% by mass. In cases where the content is less than 5% by mass, satisfactory images may not be reproduced upon reproducing, and in cases where the content is more than 50% by mass, images may not be correctly reproduced due to scattering of reproducing light.

Matrix

In the first embodiment, the matrix contains a polyfunctional isocyanate, a radical-polymerizable compound and a polyfunctional alcohol, and also other ingredients as required.

In the second embodiment, the matrix contains a polyfunctional isocyanate, a monofunctional radical-polymerizable compound and a polyfunctional alcohol, and also other ingredients as required.

Preferably, the matrix is a three-dimensionally crosslinked urethane matrix; which is employed to enhance the coating property, film strength and hologram recording property and is selected properly in view of compatibility with the monomer.

Radical-Polymerizable Compound

In the first embodiment, the radical-polymerizable compound has at least one of an amino group, a carboxyl group, an acid anhydride and an isocyanate group. The radical-polymerizable compound, utilized for the matrix, may be monofunctional or polyfunctional.

In the second embodiment, the radical-polymerizable compound has a hydroxyl group. The radical-polymerizable compound, utilized for the matrix, is monofunctional.

The polymerizable group of the radical-polymerizable compound is, for example, an acryloyl group, methacryloyl group, styryl group, allyl group and vinyl group, preferable is acryloyl group, methacryloyl group, allyl group and styryl group, more preferable is acryloyl group and methacryloyl group.

The content of the polymerizable groups in the radical-polymerizable compounds is preferably 1% by mass to 50% by mass, more preferably 1% by mass to 30% by mass. It is also preferred that the mole equivalent of isocyanate group and the modified or remaining alcohol equivalent are approximate.

Examples of the radical-polymerizable compounds having a hydroxyl group include hydroxyethyl acrylate, hydroxyethyl methacrylate, hydroxypropyl acrylate, hydroxybutyl acrylate, hydroxymethyloxy acrylate, hydroxymethyloxy methacrylate, hydroxyethyloxy acrylate, hydroxyethyloxy methacrylate, 2-hydroxy-3-phenoxypropyl acrylate, 2-hydroxy-3-phenoxypropyl methacrylate, allyl alcohol, pentaerythritol diacrylate, pentaerythritol triacrylate, pentaerythritol dimethacrylate, pentaerythritol trimethacrylate, 2-hydroxy-3-acryloxypropylacrylate and 4-hydroxy-1-butylene. These may be used alone or in combination of two or more. Among these, hydroxyethyl acrylate, hydroxybutyl acrylate, hydroxyethyl methacrylate and hydroxymethylstyrene are preferable in particular.

The radical-polymerizable compounds having an amino group may be primary or secondary; example thereof include aminoethyl acrylate, aminoethyl methacrylate, aminopropyl acrylate, aminobutyl acrylate, aminomethyloxy acrylate, aminomethyloxy methacrylate, aminoethyloxy acrylate, aminoethyloxy methacrylate, aminopropyl, 2-amino-3-phenoxypropyl acrylate, 2-amino-3-phenoxypropyl methacrylate, allylamine, N-methylaminoethyl acrylate, N-methylaminoethyl methacrylate, N-methylaminopropyl acrylate, N,N-diacryloyl ethylamine, allylamine and aminomethylstyrene. These may be used alone or in combination of two or more. Among these, preferable are aminoethyl acrylate, N,N-diacryloyl ethylamine, aminopropyl acrylate and aminomethylstyrene in particular.

Examples of the radical-polymerizable compounds having a carboxyl group include 3-acryloyloxy propionic acid, 4-acryloyloxy butyric acid, 3-acryloyloxy isobutyric acid, 5-acryloyloxy pentanoic acid, 4-acryloyloxy pentanoic acid, 6-acryloyloxy pentanoic acid and 8-acryloyloxy octanoic acid. These may be used alone or in combination of two or more. Among these, 3-acryloyloxy propionic acid and 4-acryloyloxy butyric acid are preferable in particular.

Examples of the radical-polymerizable compounds having an acid anhydride include 3-acryloyloxy propionic acid anhydride, 4-acryloyloxy butyric acid anhydride, 3-acryloyloxy isobutyric acid anhydride, 5-acryloyloxy pentanoic acid anhydride, 4-acryloyloxy pentanoic acid anhydride, 6-acryloyloxy pentanoic acid anhydride and 8-acryloyloxy octanoic acid anhydride. These may be used alone or in combination of two or more. Among these, 3-acryloyloxy propionic acid anhydride and 4-acryloyloxy butyric acid anhydride are preferable in particular.

Examples of the radical-polymerizable compounds having an isocyanate group include ethylisocyanate acrylate, ethylisocyanate methacrylate, propylisocyanate acrylate, propylisocyanate methacrylate, butylisocyanate acrylate, butylisocyanate methacrylate, allylisocyanate, 1-butylene isocyanate, 2-acryloyloxymethylisocyanate ethylacrylate and methylisocyanate styrene. These may be used alone or in combination of two or more. Among these, ethylisocyanate acrylate, butylisocyanate acrylate and methylisocyanate styrene are preferable in particular.

Polyfunctional Isocyanate

The polyfunctional isocyanates may be of lower molecular-weight or higher molecular-weight; examples thereof include biscyclohexyl methanediisocyanate, hexamethylene diisocyanate, phenylene-1,3-diisocyanate, phenylene-1,4-diisocyanate, 1-methoxyphenylene-2,4-diisocyanate, 1-methylphenylene-2,4-diisocyanate, 2,4-thrylenediisocyanate, 2,6-thrylenediisocyanate, 1,3-xylylenediisocyanate, 1,4-xylylenediisocyanate, biphenylene-4,4′-diisocyanate, 3,3′-dimethoxybiphenylene-4,4′-diisocyanate, 3,3′-dimethylbiphenylene-4,4′-diisocyanate, diphenylmethane-2,4′-diisocyanate, diphenylmethane-4,4′-diisocyanate, 3,3′-dimethoxydiphenylmethane-4,4′-diisocyanate, 3,3′-dimethyldiphenylmethane-4,4′-diisocyanate, naphthylene-1,5-diisocyanate, cyclobutylene-1,3-diisocyanate, cyclopentylene-1,3-diisocyanate, cyclohexylene-1,3-diisocyanate, cyclohexylene-1,4-diisocyanate, 1-methylcyclohexylene-2,4-diisocyanate, 1-methylcyclohexylene-2,6-diisocyanate, 1-isocyanate-3,3,5-trimethyl-5-isocyanatemethylcyclohexane, cyclohexane-1,3-bis(methylisocyanate), cyclohexane-1,4-bis(methylisocyanate), isophoronediisocyanate, dicyclohexylmethane-2,4′-diisocyanate, dicyclohexylmethane-4,4′-diisocyanate, ethylenediisocyanate, tetramethylene-1,4-diisocyanate, hexamethylene-1,6-diisocyanate, dodecamethylene-1,12-diisocyanate, phenyl-1,3,5-triisocyanate, diphenylmethane-2,4,4′-triisocyanate, diphenylmethane-2,5,4′-triisocyanate, triphenylmethane-2,4′,4″-triisocyanate, triphenylmethane-4,4′,4″-triisocyanate, diphenylmethane-2,4,2′,4′-tetraisocyanate, diphenylmethane-2,5,2′,5′-tetraisocyanate, cyclohexane-1,3,5-triisocyanate, cyclohexane-1,3,5-tris(methylisocyanate), 3,5-dimethylcyclohexane-1,3,5-tris(methylisocyanate), 1,3,5-trimethylcyclohexane-1,3,5-tris(methylisocyanate), dicyclohexylmethane-2,4,2′-triisocyanate and dicyclohexylmethane-2,4,4′-triisocyanatelysine diisocyanatemethylester and also prepolymers having isocyanates at both ends that are prepared by reaction between these organic isocyanate compounds of over stoichiometric quantities and polyfunctional compounds containing an active hydrogen. These may be used alone or in combination of two or more. Among these, biscyclohexyl methanediisocyanate and hexamethylene diisocyanate are preferable in particular.

Polyfunctional Alcohol

The polyfunctional alcohols may be of lower molecular-weight or higher molecular-weight; examples thereof include glycols such as ethylene glycol, diethylene glycol, triethylene glycol, polyethylene glycol, propylene glycol, polypropylene glycol and neopentyl glycol; diols such as butanediol, pentanediol, hexanediol, heptanediol and tetramethylene glycol; triols such as glycerin, trimethylol propane, butanetriol, pentanetriol, hexanetriol, polypropyleneoxide triol and decanetriol; polyphenols such as catechol and resorcinol; bisphenols; and these polyfunctional compounds modified with polyethyleneoxy chains. These may be used alone or in combination of two or more. Among these, tetramethylene glycol, polypropyleneoxide triol and trimethylolpropane are preferable in particular.

The mass ratio of (A) the polyfunctional isocyanate, (B) the radical-polymerizable compound, which may be polyfunctional or monofunctional, and (C) the polyfunctional alcohol, in terms of the mixture in the matrix, is preferably 20 to 80:1 to 20:19 to 80, more preferably 40 to 70:1 to 10:29 to 70. In cases where the mass ratio is outside this range, the curability of the matrix may be insufficient.

The other ingredients described above are exemplified by thermosetting catalysts for three-dimensionally crosslinking the matrix. Examples of the thermosetting catalysts include primary amines, secondary amines, tertiary amines, unsaturated amines, cyclic unsaturated amines, tin catalysts and titanium catalysts. These may be used alone or in combination of two or more.

Specific examples of the primary, secondary and tertiary amines are hexylamine, octylamine, decylamine, dibutylamine, di-tert-butylamine, dihexylamine, dicyclohexylamine, dioctylamine, triethylamine, trihexylamine, diisobutylethylamine, dicyclohexylmethylamine, dimethylethylenediamine, tetramethylethylenediamine, piperazine, pyrrolidine and piperidine.

Specific examples of the unsaturated amines and cyclic unsaturated amines are pyridine, pyrrole, diazabicyclooctane, diazabicyclononane and diazabicycloundecene. Specific examples of the tin catalysts are dibutyltinraurate and tin di-2-ethylhexanoate. Specific example of the titanium catalysts is tetraisobutylalkoxy titanium.

The content of the catalysts described above may be properly selected depending on the application as long as urethane compounds can be produced; preferably, the content is 0.01% by mass to 10% by mass based on the total mass of the matrix, more preferably 0.01% by mass to 5% by mass, still more preferably 0.1% by mass to 1% by mass.

The content of the matrix is preferably 10% by mass to 95% by mass in the optical recording composition, more preferably 35% by mass to 90% by mass. In cases where the content is less than 10% by mass, the recording layers formed from the optical recording compositions may not yield stable interference images, and in cases where more than 95% by mass, desirable properties may be difficult to obtain in terms of diffraction efficiencies.

Photopolymerization Initiator

The photopolymerization initiator may be selected from anything as long as sensitive to recording lights, for example, from substances capable of inducing a radical polymerization reaction; specific examples of the photopolymerization initiator include 2,2′-bis(o-chlorophenyl)-4,4′,5,5′-tetraphenyl-1,1′-biimidazole, 2,4,6-tris(trichloromethyl)-1,3,5-triazine, 2,4-bis(trichloromethyl)-6-(p-methoxyphenylvinyl)-1,3,5-triazine, diphenyliodoniumtetrafluoroborate, diphenyliodoniumhexafluorophosphate, 4,4′-di-t-butyldiphenyliodoniumtetrafluoroborate, 4-diethylaminophenylbenzenediazonium hexafluorophosphate, benzoin, 2-hydroxy-2-methyl-1-phenylpropane-2-one, benzophenone, thioxanthone, 2,4,6-trimethylbenzoyldiphenylacyl phosphineoxide, triphenylbutylborate tetraethylammonium, bis(η⁵-2,4-cyclopentadiene-1-yl), bis[2,6-difluoro-3-(1H-pyrrole-1-yl)phenyltitanium], and diphenyl-4-phenylthiophenylsulfonium hexafluorophosphate. These may be used alone or in combination of two or more. The sensitizing dyes described later may also be added so as to adapt with irradiating wavelengths.

Preferably, the content of the photopolymerization initiator is 0.01% by mass to 5% by mass in the optical recording composition, more preferably 1% by mass to 3% by mass.

Other Ingredients

The other ingredients described above may be a polymerization inhibitor or antioxidant for improving the preservation stability of the optical recording compositions.

The polymerization inhibitor or antioxidant may be, for example, hydroquinone, p-benzoquinone, hydroquinone monomethylether, 2,6-di-tert-butyl-p-cresol, 2,2′-methylenebis(4-methyl-6-tert-butylphenol), triphenylphosphite, trisnonyl phenylphosphite, phenothiazine or N-isopropyl-N′-phenyl-p-phenylene diamine.

The content of the polymerization inhibitor or antioxidant described above is less than 3% by mass based on the total mass of the monomers. In cases where the content is more than 3% by mass, the polymerization tends to delay or cease in some cases.

The optical recording compositions may be added with sensitizing dyes as required. The sensitizing dyes may be conventional compounds described in “Research Disclosure, vol. 200, December 1980, Item 20036” or “Sensitizer, pp. 160-163, Kodansha Ltd., ed. Katsumi Tokumaru and Shin Ohgawara, 1987.” Specific examples of the sensitizing agents are 3-ketocoumarin compounds described in JP-A No. 58-15603; thiopyrylium salts described in JP-A No. 58-40302; naphthothiazole merocyanine compounds described in Japanese Patent Application Publication (JP-B) Nos. 59-28328 and 60-53300; and merocyanine compounds described in JPB Nos. 61-9621 and 62-3842, JP-A Nos. 59-89303 and 60-60104. Furthermore, the sensitizing agents may be the dyes described in “Functional Dye Chemistry, 1981, CMC Publishing Co., pp. 393-416” or “Color Material, 60 (4), 212-224 (1987)”; more specific are cationic methine dyes, cationic carbonium dyes, cationic quinonimine dyes, cationic indoline dyes and cationic styryl dyes. Still furthermore, the sensitizing agents may keto dyes such as coumarin dyes including ketocoumarin and sulfocoumarin, merostyryl dyes, oxonol dyes and hemioxonol dyes; non-keto dyes such as non-keto polymethine dyes, triarylmethane dyes, xanthen dyes, anthracene dyes, rhodamine dyes, acridine dyes, aniline dyes and azo dyes; non-keto polymethine dyes such as azomethine dyes, cyanine dyes, carbocyanine dyes, dicarbocyanine dyes, tricarbocyanine dyes, hemicyanine dyes and styryl dyes; and quinonimine dyes such as azine dyes, oxazin dyes, thiazin dyes, quinoline dyes and thiazole dyes. The sensitizing agents may be used alone or in combination of two or more.

The optical recording compositions may be added with photothermal conversion materials so as to enhance the sensitivity of recording layers formed from the optical recording compositions.

The photothermal conversion materials may be properly selected depending on the intended performance or capability; the materials are preferably organic dyes from the viewpoint that the materials may be conveniently included into recording layers along with photopolymers and incident lights may be far from scattering, in addition the materials are preferably infrared-ray absorbing dyes from the viewpoint that the recording lights may be far from absorption and/or scattering.

The infrared-ray absorbing dyes may be properly selected depending on the application; preferably, the dyes are cationic dyes, complex-salt forming dyes and quinone neutral dyes. The maximum absorption wavelength of the infrared-ray absorbing dyes is preferably 600 nm to 1000 nm, particularly preferable is 700 nm to 900 nm.

The content of the infrared-ray absorbing dyes may be determined depending on the absorbance at infrared region of the resulting recording materials; preferably the absorbance is 0.1 to 2.5, more preferably 0.2 to 2.0.

Furthermore, in order to reduce the volume change at polymerization, the optical recording compositions may be added with an ingredient that can diffuse into the inverse direction with that of polymerizable ingredients, or compounds having an acid cleavage configuration may be added in addition to the polymers as required.

Method for Producing Optical Recording Composition

In the first embodiment, the inventive methods for producing an optical recording medium comprise a step of forming a matrix, in which a polyfunctional isocyanate, a radical-polymerizable compound having at least one of an amino group, a carboxyl group, an acid anhydride and an isocyanate group, and a polyfunctional alcohol are mixed and thermosetted thereby to form a three-dimensional crosslinked matrix, and other steps as required.

In the second embodiment, the inventive methods for producing an optical recording composition comprises a step of forming a matrix, in which a polyfunctional isocyanate, a monofunctional radical-polymerizable compound having a hydroxyl group, and a polyfunctional alcohol are mixed and thermosetted thereby to form a three-dimensional crosslinked matrix, and other steps as required.

The respective compounds may be added all together or sequentially, in the first and second embodiments with respect to the step of forming a matrix described above; preferably, these compounds are added all together in view of simple and easy production processes.

Then the resulting matrix, the monomer, optimally the photopolymerization initiator and other ingredients are compounded to prepare the optical recording composition according to the present invention.

The optical recording compositions according to the present invention may be applied for various compositions capable of recording information by way of informative optical irradiation, preferably applied as compositions for volume holographic recording in particular.

When the optical recording compositions are of sufficiently low viscosities, the recording layers may be formed by way of casting. On the other hand, when being excessively viscous for the casting, the recording layers are mounted on the lower substrate by use of a dispenser, then the recording layer is pressed by the upper substrate in a manner that the upper substrate covers the recording layer to spread entirely to form the optical recording medium.

Method for Determining Whether Radical Polymerizable Compound Having at Least One of Amino Group, Carboxyl Group, Hydroxyl Group, Acid Hydride and Isocyanate Group

When the radical polymerizable compound has an amino group, a hydroxyl group or an isocyanate group, the urethane bond or urea bond attached to the matrix may be cut off by treating the holographic recording layer using acids or bases, the corresponding amines or alcohols are detected, thereby the presence of amino group, hydroxyl group or isocyanate group may be confirmed.

Optical Recording Medium

The inventive optical recording medium comprises a holographic recording layer formed from the inventive optical recording composition, and also preferably comprises a lower substrate, filter layer, holographic recording layer, upper substrate, reflective film, first gap layer, second gap layer and other layers as required.

The optical recording medium described above may be properly selected as long as capable of recording and reproducing on the basis of hologram, for example, may be of relatively thin plane holograms to record two-dimensional information or volume holograms to record numerous information such as stereo images, alternatively of transmissive or reflective type. The recording mode of the hologram may be, for example, of amplitude hologram, phase hologram, brazed hologram or complex amplitude hologram. Among these, so-called Collinear system is preferable in particular in which an informing light and a reference light are irradiated as a coaxial light beam, and information is recorded on the recording region by an interference pattern generated by the interference between the informing light and the reference light.

Substrate

The substrate may be properly selected depending on the purpose as for the shape, configuration, size etc.; the shape may be disc-like, card-like etc.; the material is required for the mechanical strength in terms of the hologram recording media. In the case that the light for recording or reproducing is directed through the substrate, it is necessary that the substrate is sufficiently transparent at the wavelength region of the employed light.

The material of the substrate is usually selected from glasses, ceramics, resins etc.; preferably, resins are employed in particular from the view point of formability and cost.

Examples of the resins include polycarbonate resins, acrylic resins, epoxy resins, polystyrene resins, acrylonitrile-styrene copolymers, polyethylene resins, polypropylene resins, silicone resins, fluorine resins, ABS resins and urethane resins. Among these, polycarbonate resins and acrylic resins are most preferable in view of their formability, optical characteristics and costs. The substrate may be properly prepared or commercially available.

Plural address-servo areas, i.e. addressing areas linearly extending in the radial direction of the substrate, are provided on the substrate at a given angle to one another, and each sector-form area between adjacent address-servo areas serves as a data area. In the address-servo areas, information for a focus servo operation and a tracking servo operation by means of a sampled servo system and address information are previously recorded (or pre-formatted) in the form of emboss pits (servo pits). The focus servo operation can be performed using a reflective surface of the reflective film. For example, wobble pits may be used as the information for tracking servo. The servo pit pattern is not necessarily required in the case that the optical recording medium is card-like shape.

The thickness of the substrate may be properly selected depending on the purpose; the thickness is preferably 0.1 mm to 5 mm, more preferably 0.3 mm to 2 mm. When the thickness of the substrate is less than 0.1 mm, the optical disc may be deformed during its storage; and when the thickness is more than 5 mm, the weight of the optical disc may be as heavy as excessively loading on the drive motor.

Recording Layer

Information can be recorded onto the recording layer, which being formed from the optical recording composition, by use of holography.

The thickness of the recording layer may be properly selected depending on the application; the thickness is preferably 1 μm to 1,000 μm, more preferably 100 μm to 700 μm. When the thickness of the recording layer is within the preferable range, the sufficient S/N ratio may be attained even on the shift multiplex of 10 to 300; and the more preferable range may advantageously lead to more significant effect thereof.

Reflective Film

The reflective film is formed on the surface of the servo pit pattern of the substrate. As for the material of the reflective film, such material is preferable that provides the recording light and the reference light with high reflectivity. When the wavelength of light is 400 nm to 780 nm, Al, Al alloys, Ag, Ag alloys and the like are preferably used. When the wavelength of light is 650 nm or more, Al, Al alloys, Ag. Ag alloys, Au, Cu alloys, TiN and the like are preferably used.

By use of DVD (digital video disc), for example, as the optical recording medium capable of reflecting the light and also recording and erasing information, such directory information can be recorded and erased without adversely affecting holograms as those indicative of the locations where information being recorded, the time when the information being recorded, and the locations where errors being occurred and exchanged.

The process for forming the reflective film may be properly selected depending on the purpose; examples thereof include various types of vapor deposition, such as vacuum vapor deposition, sputtering, plasma CVD, photo CVD, ion plating, and electron beam vapor deposition. Among these, sputtering is most preferable in view of mass productivity, film quality, and the like. The thickness of the reflective film is preferably 50 nm or more, more preferably 100 nm or more, in order to secure sufficient reflectivity.

First Gap Layer

The first gap layer is provided between the filter layer and the reflective film as required for smoothing the surface of the substrate. Furthermore, the first gap layer is effective to adjust the size of the hologram formed in the recording layer. Specifically, the gap layer between the recording layer and the servo pit pattern may be effective, since the recording layer requires the interference region of some larger size between the recording reference light and the informing light.

The first gap layer can be formed by, for example, applying UV curable resin etc. on the servo pit pattern by spin coating etc. and by curing the resin. In addition, when a filter layer is formed on a transparent base material, the transparent base material also serves as the first gap layer. The thickness of the first gap layer may be properly selected depending on the purpose; the thickness is preferably 1 μm to 200 μm.

Filter Layer

The filter layer is provided on the servo pit of the substrate, on the reflective layer, or on the first gap layer.

The filer layer performs wavelength-selective reflection in a manner that a light with a certain wavelength may be solely reflected among plural lights or beams. The filter layer may perform in particular to prevent diffuse reflection of the informing light and the reference light from the reflective film of the optical recording medium and to prevent noise generation without the sift of selective reflection wavelength even if the incident angle being altered; therefore, the lamination of the filter layer with the optical recording medium may achieve optical recording with excellently high resolution and diffraction efficiency.

The filter layer may be properly selected depending on the purpose; for example, the filter layer may be formed of a laminated body containing a dichroic mirror layer, a color material-containing layer, a dielectric vapor deposition layer, a cholesteric layer of mono layer or two or more layers, and other layers properly selected as required.

The filter layer may be laminated directly to the substrate by way of coating etc. along with the recording layer; alternatively, a filter for optical recording media is prepared by laminating on a base material such as films, then the filter for an optical recording medium may be laminated on the substrate.

Second Gap Layer

The second gap layer may be provided between the recording layer and the filter layer as required.

The material for the second gap layer may be properly selected depending on the purpose; examples thereof include transparent resin films such as triacetylcellulose (TAC), polycarbonate (PC), polyethylene terephthalate (PET), polystyrene (PS), polysulfone (PSF), polyvinylalcohol (PVA) and methyl polymethacrylate (PMMA); norbornene resin films such as ARTON (product name, by JSR Corp.), ZEONOA (product, by Nippon Zeon). Among these, those with higher isotropy are preferable, and TAC, PC, ARTON and ZEONOA are most preferable.

The thickness of the second gap layer may be properly selected depending on the purpose; the thickness is preferably 1 μm to 200 μm.

The optical recording media according to the present invention will be explained more specifically with reference to figures.

### First Embodiment

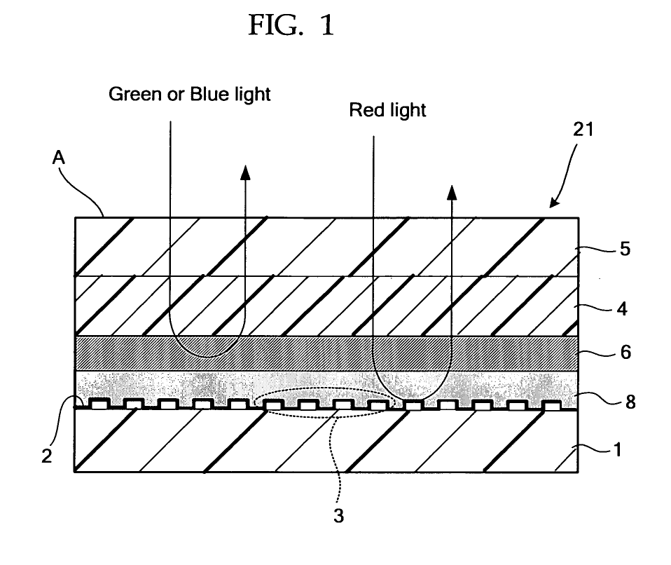

FIG. 1 is a schematic cross-sectional view showing the structure of the first embodiment of the optical recording medium in the present invention. In the optical recording medium 21 according to the first embodiment, servo pit pattern 3 is formed on the second substrate 1 made of a polycarbonate resin or glass, and the servo pit pattern 3 is coated with Al, Au, Pt or the like to form reflective film 2. Although the servo pit pattern 3 is formed on the entire surface of the second substrate 1 in FIG. 1, it may be formed periodically. The height of the servo pit pattern 3 is usually 1750 angstroms (175 nm), which being significantly smaller than the other layers including the substrate.

The first gap layer 8 is formed by applying UV curable resin or the like on the reflective film 2 of the second substrate 1 by spin coating or the like. The first gap layer 8 is effective for protecting the reflective film 2 and for adjusting the size of holograms created in recording layer 4. Specifically, the interference region between the recording reference light and the informing light requires a level of size in the recording layer 4, a clearance is effectively provided between the recording layer 4 and the servo pit pattern 3.

The filter layer 6 is provided on the first gap layer 8, the second gap layer 7 is provided between the filter layer 6 and the first substrate 5 (polycarbonate resin or glass substrate), and the recording layer 4 is sandwiched to thereby constitute the optical recording medium 21.

In FIG. 1, the filter layer 6 transmits only red light and blocks other color lights. Since the informing light, recording light and reproducing reference light are of green or blue, they do not pass through the filter layer 6 instead turn into a return light to emit from the entrance/exit surface A without reaching the reflective film 2.

The filter layer 6 is a multilayer vapor-deposited film consisting of alternatively laminated higher refractive-index layers and lower refractive-index layers. The filter layer 6 of the multilayer vapor-deposited film may be formed directly onto the first gap layer 8 by vacuum vapor deposition, alternatively may be disposed by punching through the multilayer vapor-deposited film formed on the substrate into the shape of the optical recording medium.

The optical recording medium 21 of this embodiment may be of disc shape or card shape. The servo pit pattern is unnecessary in the case of card shape. In the optical recording medium 21, the lower substrate 1 is 0.6 mm thick, the first gap layer 8 is 100 μm thick, the filter layer 6 is 2 μm to 3 μm thick, the recording layer 4 is 0.6 mm thick, and the upper substrate 5 is 0.6 mm thick, leading to the total thickness of about 1.9 mm.

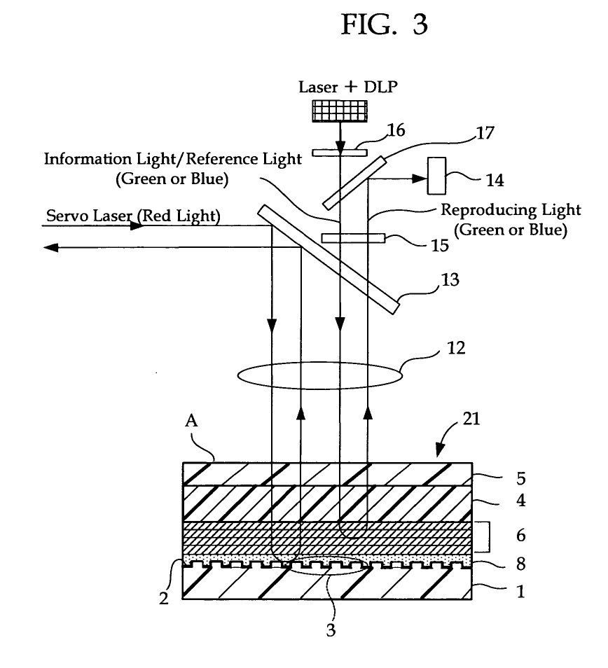

The optical operations around the optical recording medium 21 will be explained with reference to FIG. 3 in the following. Initially, red light emitted from the servo laser source is reflected by dichroic mirror 13 by almost 100%, and passes through objective lens 12. The servo light 10 is applied onto the optical recording medium 21 in such a way that it focuses on the reflective film 2. More specifically, the dichroic mirror 13 is configured to transmit only green or blue light but reflect almost 100% of red light. The servo light incident from the light entrance/exit surface A of the optical recording medium 21 passes through the upper substrate 5, recording layer 4, filter layer 6 and first gap layer 8, then is reflected by the reflective film 2, and passes again through the first gap layer 8, filter layer 6, recording layer 4 and upper substrate 5 to emit from the light entrance/exit surface A. The emitted return light passes through the objective lens 12 and is reflected by the dichroic mirror 13 by almost 100%, and then a servo information detector (not shown) detects servo information. The detected servo information is used for the focus servo operation, tracking servo operation, slide servo operation and the like. The hologram material constituting the recording layer 4 is designed so as to be insensitive to red light, therefore, even when the servo light passes through the recording layer 4 or reflects diffusively at the reflective film 2, the recording layer 4 is not adversely affected. In addition, the return servo light reflected by the reflective film 2 is reflected almost 100% by the dichroic mirror 13, accordingly, the servo light is non-detectable by CMOS sensor or CCD 14 used for the detection of reconstructed images, thus providing the diffracted light with no noise.

Both of the informing light and the recording reference light emitted from the recording/reproducing laser source pass through the polarizing plate 16 to form a linear polarization then to form a circular polarization after passing through the half mirror 17 and the quarter wave plate 15. The circular polarization then passes through the dichroic mirror 13, and illuminates the optical recording medium 21 by action of the objective lens 12 in a manner that the informing light and the reference light create an interference pattern in the recording layer 4. The informing light and reference light enter from the light entrance/exit surface A and interact with each other in the recording layer 4 to form and record an interference pattern. Thereafter, the informing light and reference light pass through the recording layer 4 and enter into the filter layer 6, and then, are reflected to turn into a return light before reaching the bottom of the filter layer 6. That is, the informing light and recording reference light do not reach the reflective film 2. This is because the filter layer 6, which being a multilayer vapor-deposited film consisting of alternatively laminated higher refractive-index layers and lower refractive-index layers, allows to exclusively transmit red light.

### Second Embodiment

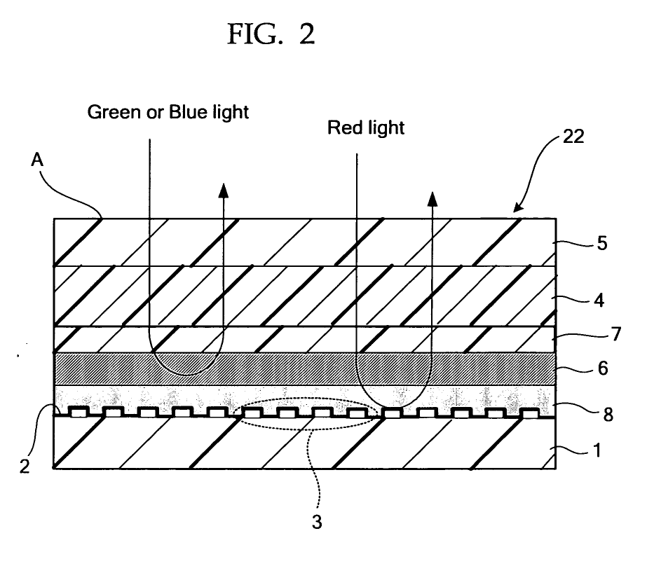

FIG. 2 is a schematic cross-sectional view showing the configuration of the second embodiment of the inventive optical recording medium. In the optical recording medium 22 of the second embodiment, servo pit pattern 3 is formed on the second substrate 1 made of polycarbonate resin or glass, and the servo pit pattern 3 is coated with Al, Au, Pt or the like to form the reflective film 2. The height of the servo pit pattern 3 is usually 1750 angstroms (175 nm), which being similar with the first embodiment.

The difference between the first embodiment and the second embodiment is that the second gap layer 7 is disposed between the filter layer 6 and the recording layer 4 in the optical recording medium 22 of the second embodiment. The second gap layer 7 involves a point at which the informing light and the reference light focus. Provided that this area is filled with a photopolymer, the monomer is likely to be excessively consumed by action of excessive exposure, resulting in decrease of multiple recording capacity. Accordingly, the nonreactive transparent second gap is effectively provided.

The filter layer 6 of a multilayer vapor-deposited film, consisting of alternatively laminated higher refractive-index layers and lower refractive-index layers, is formed on the first gap layer 8 after the first gap layer 8 being formed. The filter layer 6 may be similar as that of the first embodiment.

In the optical recording medium 22 of the second embodiment, the lower substrate 1 is 1.0 mm thick, the first gap layer 8 is 100 μm thick, the filter layer 6 is from 3 μm to 5 μm thick, the second gap layer 7 is 70 μm thick, the recording layer 4 is 0.6 mm thick, the upper substrate 5 is 0.4 mm thick, and the total thickness is about 2.2 mm.

Upon recording and reproducing information, the optical recording medium 22 having the structure described above is irradiated with a red servo light and a green informing light as well as a recording light and a reproducing reference light. The servo light enters from the light entrance/exit surface A, passes through the recording layer 4, the second gap layer 7, the filter layer 6, and the first gap layer 8, and is reflected by the reflective film 2 to turn into a return light. This return light sequentially passes through the first gap layer 8, the filter layer 6, the second gap layer 7, the recording layer 4 and upper substrate 5, and emits from the light entrance/exit surface A. The emitted return light is utilized for the focus servo operation, tracking servo operation and the like. The hologram material of the recording layer 4 is designed to be non-sensitive to red light; therefore, the recording layer 4 receives no influence even when the servo light has passed through the recording layer 4 or has been reflected diffusively by the reflective film 2. The green informing light and the reference light etc. enter from the light entrance/exit surface A, then pass through the recording layer 4 and second gap layer 7, and reflected by the filter layer 6 to tern into a return light. The return light sequentially passes through the second gap layer 7, the recording layer 4 and first substrate 5 again, and emits from the light entrance/exit surface A. Upon reproduction of information, both of the reproducing reference light and the diffracted light generated by irradiating the reproducing reference light onto the recording layer do not reach the reflective film 2 and emit from the light entrance/exit surface A. The optical operations around the optical recording medium 22 (i.e. the objective lens 12, filter layer 6, CMOS sensor or CCD 14 of detector in FIG. 3) are similar to those in the first embodiment (FIG. 11), thus the description thereof will be omitted.

Method for Recording Optical Recording Medium and Method for Reproducing Optical Recording Medium

The method for recording an optical recording medium according to the present invention comprises irradiating an informing light and a reference light having a coherent property onto the optical recording medium according to the present invention, forming an interference image from the informing light and the reference light, and recording the interference image onto the optical recording medium.

In this method, the informing light and the reference light are irradiated onto the optical recording medium in a manner that the optical axis of the informing light is coaxial with the optical axis of the reference light, then the interference image generated by the interference between the informing light and the reference light is recorded onto the recording layer of the optical recording medium.

In the optical reproducing method according to the present invention, a reproducing light is irradiated onto the interference pattern of the recording layer which is recorded by the optical recording method according to the present invention.

In the optical recording method and the optical reproducing method according to the present invention, the informing light with a two-dimensional intensity distribution and the reference light with almost the same intensity to that of the informing light are superimposed inside the photosensitive recording layer, the resulting interference pattern formed inside the recording layer induces a distribution of the optical properties of the recording layer to thereby record such distribution as information. On the other hand, when the recorded information is to be read (reproduced), only the reference light (reproducing light) is irradiated onto the recording layer from the same direction to that irradiated at the time of recording, a light having a intensity distribution corresponding to the distribution of the optical property formed inside the recording layer is emitted from the recording layer as a diffracted light.

The optical recording method and the optical reproducing method according to the present invention may be carried out by use of the optical recording and reproducing apparatus explained below.

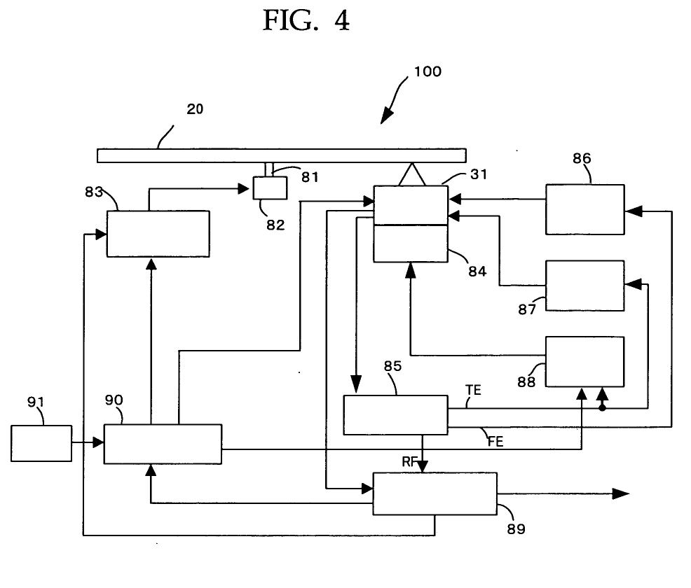

The optical recording and reproducing apparatuses applied to the optical informing method and the optical reproducing method will be explained with reference to FIG. 4.

This optical recording and reproducing apparatus 100 is equipped with spindle 81 on which the optical recording medium 20 is deposed, spindle motor 82 which rotates the spindle 81, and spindle servo circuit 83 which controls the spindle motor 82 so as to maintain the optical recording medium 20 at the predetermined revolution number.

The optical recording and reproducing apparatus 100 is also equipped with pickup unit 31 which irradiates the informing light and the reference light onto the optical recording medium so as to record information, and irradiates the reproducing reference light onto the optical recording medium 20 so as to detect the diffracted light to thereby reproduce the information recorded at the optical recording medium 20, and driving unit 84 which enables the pickup unit 31 to move in the radius direction of optical recording medium 20.

The optical recording and reproducing apparatus 100 is equipped with detecting circuit 85 which detects focusing error signal FE, tracking error signal TE, and reproducing signal RF from the output signal of the pickup unit 31, focusing servo circuit 86 which drives an actuator in the pickup unit 31 so as to move an objective lens (not shown) to the thickness direction of the optical recording medium 20 based upon the focusing error signal FE detected by the detecting circuit 85 to thereby perform focusing servo, a tracking servo circuit 87 which drives an actuator in the pickup unit 31 so as to move an objective lens (not shown) to the thickness direction of the optical recording medium 20 based upon the tracking error signal TE detected by the detecting circuit 85 to thereby perform tracking servo, and a sliding servo unit 88 which controls the driving unit 84 based upon the tracking error signal TE and an indication from a controller mentioned hereinafter so as to move the pickup unit 31 to the radius direction of the optical recording medium 20 to thereby perform sliding servo.

The optical recording and reproducing apparatus 100 is also equipped with signal processing circuit 89 which decodes output data of the CMOS or CCD array described below in the pickup unit 31, to thereby reproduce the data recorded in the data area of the optical recording medium 21, and to reproduce the standard clock or determines the address based on the reproducing signal RF from the detecting circuit 85, controller 90 which controls the whole optical recording and reproducing apparatus 100, and controlling unit 91 which gives various instructions to the controller 90. The controller 90 is configured to input the standard clock or address information outputted from the signal processing circuit 89 as well as controlling the pickup unit 31, the spindle servo circuit 83, the sliding servo circuit 88 and the like. The spindle servo circuit 83 is configured to input the standard clock outputted from the signal processing circuit 89. The controller 90 contains CPU (center processing unit), ROM (read only memory), and RAM (random access memory), the CPU realizes the function of the controller 90 by executing programs stored in the ROM on the RAM, a working area.

The optical recording and reproducing apparatuses, applied to the recording method and reproducing method of the optical recording medium according to the present invention, are equipped with the optical recording medium according to the present invention, thus can represent superior recording properties such as recording sensitivity and multiplicity and can achieve high-density recording.

The present invention will be explained with reference to examples, which are given for no more than illustration of the invention rather than for limiting its intended scope.

### EXAMPLE 1

Preparation of Optical Recording Composition

A mixture consisting of 31.5 g of biscyclohexylmethane diisocyanate (by Tokyo Chemical Industry Co.), 0.5 g of hydroxyethylacrylate, 61.2 g of polypropyleneoxide triol (molecular weight: 1000, by Aldrich Co.) and 2.5 g of tetramethylene glycol (by Aldrich Co.) was stirred at 25° C. for 1 hour thereby to obtain a matrix.

The resulting mixture and 3.1 g of 2,4,6-tribromophenylacrylate (by Dai-Ichi Kogyo Seiyaku Co.), 0.69 g of a photopolymerization initiator (by Ciba Specialty Chemicals, Irgacure 784) and 1.01 g of dibutyltin dilaurate (Wako Pure Chemical Industries, Ltd.) were mixed under nitrogen gas atmosphere to prepare an optical recording composition.

### EXAMPLE 2

Preparation of Optical Recording Composition

An optical recording composition was prepared in the same manner as Example 1 except that 0.5 g of hydroxyethylacrylate was changed into 0.5 g of hydroxybutylacrylate (by Tokyo Chemical Industry Co.).

### EXAMPLE 3

Preparation of Optical Recording Composition

An optical recording composition was prepared in the same manner as Example 1 except that 0.5 g of hydroxyethylacrylate was changed into 0.5 g of aminoethylacrylate (synthesized).

### EXAMPLE 4

Preparation of Optical Recording Composition

61.2 g of polypropyleneoxide triol (molecular weight: 1000, by Aldrich Co.) and 2.5 g of tetramethylene glycol (by Aldrich Co.) were mixed. Then 0.5 g of ethylisocyanate acrylate was added to the resulting mixture, and was stirred at 80° C. for 30 minutes.

The resulting solution described above, 31.5 g of biscyclohexyl methanediisocyanate (by Tokyo Chemical Industry Co.), 3.1 g of 2,4,6-tribromophenylacrylate (by Dai-Ichi Kogyo Seiyaku Co.), 0.69 g of a photopolymerization initiator (by Ciba Specialty Chemicals, Irgacure 784), and 1.01 g of dibutyltin dilaurate (Wako Pure Chemical Industries, Ltd.) were mixed under nitrogen gas atmosphere to prepare an optical recording composition.

### EXAMPLE 5

Preparation of Optical Recording Composition

An optical recording composition was prepared in the same manner as Example 1 except that 0.5 g of hydroxyethylacrylate was changed into 0.5 g of hydroxymethylmethacrylate (synthesized) to prepare an optical recording composition.

### EXAMPLE 6

Preparation of Optical Recording Composition

An optical recording composition was prepared in the same manner as Example 1 except that 0.5 g of hydroxyethylacrylate was changed into 0.5 g of N,N-diacryloyl ethylamine (synthesized) to prepare an optical recording composition.

### EXAMPLE 7

Preparation of Optical Recording Composition

An optical recording composition was prepared in the same manner as Example 1 except that 0.5 g of hydroxyethylacrylate was changed into 0.5 g of 3-acryloyloxy propionic acid (synthesized) to prepare an optical recording composition.

### EXAMPLE 8

Preparation of Optical Recording Composition

An optical recording composition was prepared in the same manner as Example 1 except that 0.5 g of hydroxyethylacrylate was changed into 0.5 g of 3-acryloyloxy propionic acid anhydride (synthesized) to prepare an optical recording composition.

### COMPARATIVE EXAMPLE 8

Preparation of Optical Recording Composition

31.5 g of biscyclohexylmethane diisocyanate, 61.2 g of polypropyleneoxide triol (molecular weight: 1000), 2.5 g of tetramethylene glycol, 3.1 g of 2,4,6-tribromophenylacrylate, 0.69 g of a photopolymerization initiator (by Ciba Specialty Chemicals, Irgacure 784), and 1.01 g of dibutyltin dilaurate were mixed under nitrogen gas atmosphere to prepare an optical recording composition.

### EXAMPLES 9 to 16 AND COMPARATIVE EXAMPLE 2

Preparation of Optical Recording Composition

One surface of a glass sheet having a thickness of 0.5 mm was treated into to antireflection so as to give a reflectivity of 0.1% with respect to a normal incident having a wavelength of 532 nm, to thereby obtain a first substrate. Aluminum was vapor-deposited on one surface of another glass sheet having a thickness of 0.5 mm so as to give a reflectivity of 90% with respect to a normal incident having a wavelength of 532 nm, to thereby obtain a second substrate.

Then, a spacer of transparent polyethylene terephthalate sheet having a thickness of 500 μm was disposed on the surface of the first substrate which being not treated into antireflection, then the composition for hologram recording media was applied on the first substrate. Then each of the optical recording compositions obtained in Examples 1 to 8 and Comparative Example 1 was mounted on the first substrate, then the side of the second substrate, where the aluminum being deposited, was contacted to the side of the composition of the hologram recording media on the first substrate so as to trap no air therebetween, thereby the first substrate and the second substrate were laminated along with the spacer interposed therebetween. Finally, they were allowed to stand for 24 hours at 45° C to prepare the respective optical recording media.

Recording and Evaluation

By means of Collinear hologram recording and reproducing examiner SHOT-1000 (by Pulsetec Industrial Co.), the resulting optical recording media were respectively subjected to writing a series of multiplex holograms with a recording spot diameter of 200 μm at the focal point of the hologram recording. The recorded holograms were measured and evaluated in terms of sensitivity (recording energy) and multiplex index. The results are shown in Table 1.

Measurement of Sensitivity

The resulting optical recording media were measured for the variation of bit error rate (BER) of the reproduction signal while varying the irradiation light energy (mJ/cm²) at the recording. Generally speaking, as the power of the recording beam is increased, the brightness of the reproduction signal increases and the BER of the reproduction signal tends to gradually decrease. In this case, the recording photosensitivity was determined with respect to the minimum irradiation light energy which provided an approximately clear reproduced image (BER<10⁻³).

Evaluation of Multiplex Index

As a multiplex index evaluation for the optical recording medium, a method described in “ISOM′04, Th-J-06, pp. 184-185, October 2004” was applied. In this method, a recording spot was made shifted in a spiral direction to evaluate the multiplex index. Here, the number of the recorded hologram was set at 13×13=169 holograms, and the recording pitch was set at 28.5 μm. The multiplex index was 49 at the final (169th) hologram recording. As the number of the recorded holograms is increased, the multiplex index is increased; therefore, insufficient multiplicity results in increase of the BER as the recorded number increases. Accordingly, the number of the recording hologram volume at BER>10⁻³ was determined as the multiplex property M of the optical recording medium.

| | |
|---|---|
| Optical Recording | Recording Property |

| | Composition | Sensitivity | Multiplicity |
|---|---|---|---|
| Ex. 9 | Ex. 1 | 42 | 90 |
| Ex. 10 | Ex. 2 | 39 | 96 |
| Ex. 11 | Ex. 3 | 54 | 88 |
| Ex. 12 | Ex. 4 | 42 | 93 |
| Ex. 13 | Ex. 5 | 38 | 80 |
| Ex. 14 | Ex. 6 | 42 | 87 |
| Ex. 15 | Ex. 7 | 40 | 87 |
| Ex. 16 | Ex. 8 | 42 | 90 |
| Com. Ex. 2 | Com. Ex. 1 | 80 | 70 |

The results of Table 1 demonstrate that the optical recording media of Examples 9 to 16 formed from the optical recording compositions of Examples 1 to 8, which were produced using no solvents, exhibit improvements of recording properties in recording sensitivity and multiplicity compared to the optical recording medium of Comparative Example 2 formed from the optical recording composition of Comparative Example 1.

The optical recording compositions according to the present invention afford production of high-sensitivity, high multiplicity optical recording media with higher efficiencies and lower costs with no use of solvents, thus are adapted to produce various optical recording media of hologram-type capable of recording high-density images.

What is claimed is:

1. An optical recording composition, comprising a matrix and a monomer,
wherein the matrix comprises a polyfunctional isocyanate, a radical-polymerizable compound and a polyfunctional alcohol, and
the radical-polymerizable compound comprises at least one of an amino group, a carboxyl group, an acid anhydride and an isocyanate group.

2. The optical recording composition according to claim 1, wherein the polymerizable group of the radical-polymerizable compound is one of an acryloyl group, a methacryloyl group, an allyl group and a styryl group.

3. The optical recording composition according to claim 1, wherein the mass ratio of (A) the polyfunctional isocyanate, (B) the radical-polymerizable compound and (C) the polyfunctional alcohol is 20 to 80:1 to 20:19 to 80 in terms of (A:B:C).

4. The optical recording composition according to claim 1, wherein the matrix is a three-dimensionally crosslinked urethane matrix.

5. The optical recording composition according to claim 1, further comprising a photopolymerization initiator.

6. The optical recording composition according to claim 1, wherein the monomer is one of radical-polymerizable monomers.

7. An optical recording composition, comprising a matrix and a monomer,
wherein the matrix comprises a polyfunctional isocyanate, a monofunctional radical-polymerizable compound and a polyfunctional alcohol, and
the monofunctional radical-polymerizable compound comprises a hydroxyl group.

8. The optical recording composition according to claim 7, wherein the polymerizable group of the radical-polymerizable compound is one of an acryloyl group, a methacryloyl group, an allyl group and a styryl group.

9. The optical recording composition according to claim 7, wherein the mass ratio of (A) the polyfunctional isocyanate, (B) the radical-polymerizable compound and (C) the polyfunctional alcohol is 20 to 80:1 to 20:19 to 80 in terms of (A:B:C).

10. The optical recording composition according to claim 7, wherein the matrix is a three-dimensionally crosslinked urethane matrix.

11. The optical recording composition according to claim 7, further comprising a photopolymerization initiator.

12. The optical recording composition according to claim 7, wherein the monomer is one of radical-polymerizable monomers.

13. A method for producing an optical recording composition, comprising:
mixing a polyfunctional isocyanate, a radical-polymerizable compound having at least one of an amino group, a carboxyl group, an acid anhydride and an isocyanate group, and a polyfunctional alcohol to form a mixture; and
thermosetting the mixture to form a three-dimensional crosslinked matrix.

14. A method for producing an optical recording composition, comprising:
mixing a polyfunctional isocyanate, a monofunctional radical-polymerizable compound having a hydroxyl group, and a polyfunctional alcohol to form a mixture; and
thermosetting the mixture to form a three-dimensional crosslinked matrix.

15. An optical recording medium, comprising a holographic recording layer,
wherein the holographic recording layer is formed from an optical recording composition comprising a matrix and a monomer,
the matrix comprises a polyfunctional isocyanate, a radical-polymerizable compound and a polyfunctional alcohol, and
the radical-polymerizable compound comprises at least one of an amino group, a carboxyl group, an acid anhydride and an isocyanate group.

16. The optical recording medium according to claim 15, comprising a lower substrate, a filter layer, a holographic recording layer and an upper substrate.

17. A holographic recording medium, comprising a holographic recording layer,
wherein the holographic recording layer is formed from an optical recording composition comprising a matrix and a monomer,
the matrix comprises a polyfunctional isocyanate, a monofunctional radical-polymerizable compound and a polyfunctional alcohol, and
the monofunctional radical-polymerizable compound contains a hydroxyl group.

18. The optical recording medium according to claim 17, comprising a lower substrate, a filter layer, a holographic recording layer and an upper substrate.
